(19) United States
(12) Patent Application Publication
(10) Pub. No.: US 2009/0309861 A1
(43) Pub. Date: Dec. 17, 2009

(54) POWER SUPPLY AND PLASMA DISPLAY DEVICE HAVING THE SAME

(75) Inventors: Younik NAM, Gyeonggi-do (KR); Bohyung Cho, Seoul (KR); Suyong Chae, Gyeonggi-do (KR); Woosup Kim, Seoul (KR); Byeongcheol Hyeon, Gyeongsanbuk-do (KR); Jongwon Shin, Seoul (KR)

Correspondence Address: KNOBBE MARTENS OLSON & BEAR LLP, 2040 MAIN STREET, FOURTEENTH FLOOR, IRVINE, CA, 92614, US

(73) Assignees: Samsung SDI Co., Ltd., Suwon-si (KR); SNU R&DB FOUNDATION, Seoul (KR)

(21) Appl. No.: 12/483,085

(22) Filed: Jun. 11, 2009

(30) Foreign Application Priority Data
Jun. 11, 2008 (KR) 1020080054654

(51) Int. Cl. G09G 5/00; G09G 3/28

(52) U.S. Cl. 345/211; 345/60

(57) ABSTRACT

A power supply and a plasma display device having the power supply is disclosed. The power supply reduces power used in a power factor correction unit and a DC converter by distributing the total power of the power supply between the power factor correction unit and the DC converter.

### CROSS-REFERENCE TO RELATED APPLICATIONS

This application is based on and claims priority to Korean Patent Application No. 10-2008-0054654 filed on Jun. 11, 2008, in the Korean Intellectual Property Office (KIPO), the entire contents of which are hereby incorporated by reference.

### BACKGROUND

1. Field

The field relates to a power supply and a plasma display device having the same.

2. Description of the Related Technology

Recently, flat-panel displays such as an LCD (liquid crystal display, hereinafter referred to as LCD), a FED (field emission display, hereinafter referred to as FED) and a plasma display device have been actively developed.

The plasma display device of the flat-panel devices has high luminance, light-emitting efficiency and wide viewing angle in comparison with other flat-panel displays. Accordingly, the plasma display device has been promoted as a display device that can replace conventional cathode ray tubes (hereinafter referred to as CRT) in display devices larger than 40 inches.

The plasma display device is a flat panel display used for displaying characters or images using plasma generated by a gas discharge. In the plasma display device, several tens or several millions of pixels are arranged in a matrix configuration according to its size.

In the plasma display device, the gas discharge has strong non-linearity. That is, the discharge does not occur by an applied voltage lower than a discharge starting voltage. The discharge starting voltage of the gas discharge is usually higher than 100 V. The plasma display device includes a switching mode power supply (SMPS) to apply the discharge starting voltage.

The power supply is generally formed in a two-stage serial structure that includes an active power factor correction (PFC) circuit to compensate a power factor of an input alternating current (AC) and a DC-DC converter to convert a voltage applied from the active power factor correction circuit into a voltage usable in the plasma display device. The DC-DC converter usually uses a half-bridge structure.

However, the plasma display device has a problem that requirements for each driver of the power supply is increased, because the driver is operated by the voltage higher than 100V.

### SUMMARY OF CERTAIN INVENTIVE ASPECTS

One aspect is a power supply. The power supply includes a boost unit electrically coupled to an input power, a DC converter electrically coupled to the boost unit, and a power factor correction unit, electrically coupled to the boost unit. The power factor correction unit is connected in parallel to the DC converter. The power supply also includes an output unit electrically coupled to the power factor correction unit and to the DC converter, the output unit configured to output power, where the output unit includes a first capacitor electrically coupled between output terminals of the power factor correction unit, and a second capacitor that is electrically coupled between output terminals of the DC converter and connected in serial with the first capacitor.

Another aspect is a plasma display device. The device includes a power supply, where the power supply includes a boost unit electrically coupled to an input power, a DC converter electrically coupled to the boost unit, and a power factor correction unit, electrically coupled to the boost unit. The power factor correction unit is connected in parallel to the DC converter. The power supply also includes an output unit electrically coupled to the power factor correction unit and to the DC converter, the output unit configured to output power, where the output unit includes a first capacitor electrically coupled between output terminals of the power factor correction unit, and a second capacitor that is electrically coupled between output terminals of the DC converter and connected in serial with the first capacitor.

### BRIEF DESCRIPTION OF THE DRAWINGS

The above and other aspects, features and advantages of the present invention will be more apparent from the following detailed description taken in conjunction with the accompanying drawing, in which:

FIG. 1 is a block view illustrating a plasma display device;

FIG. 2 is a circuit diagram illustrating a power supply according to one exemplary embodiment;

FIG. 3 is a timing diagram according to one exemplary embodiment of the power supply of FIG. 2; and

FIGS. 4a and 4d are circuit diagrams illustrating current flow according to the timing diagram of the power supply of FIG. 3.

### DETAILED DESCRIPTION OF CERTAIN INVENTIVE EMBODIMENTS

Hereinafter, certain embodiments will be described in detail with reference to the accompanying drawing. The aspects and features and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are specific details provided to assist those of ordinary skill in the art in understanding the invention. In the description, the same drawing reference numerals are generally used for the same elements across various figures. Further, a term of “electrically coupled” may mean not only “directly coupled” but also may include “coupled via other interposing element”.

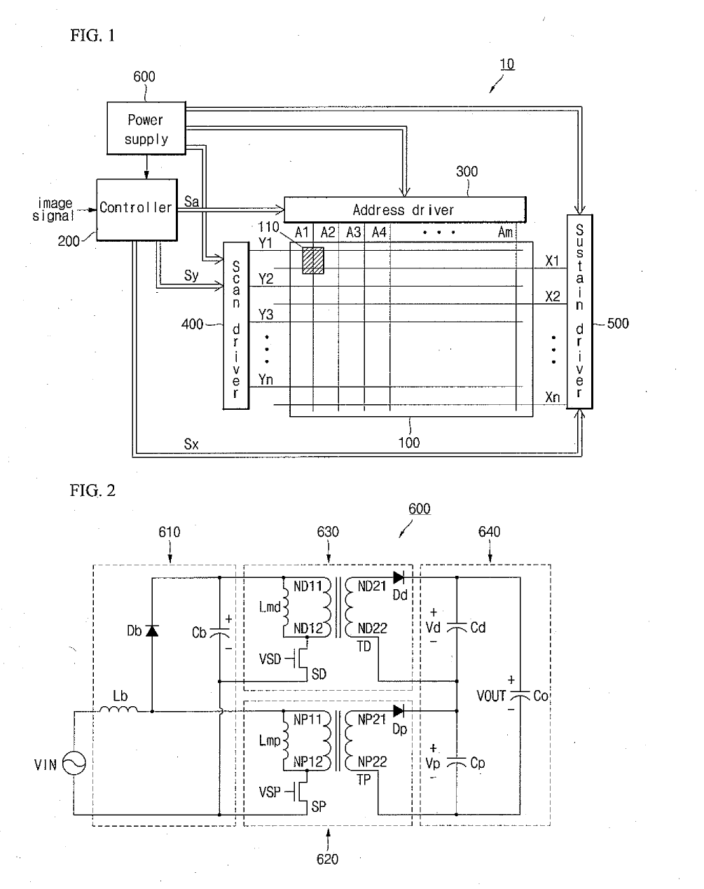

FIG. 1 is a block view of a plasma display device according to one exemplary embodiment.

Referring to FIG. 1, a plasma display device 10 includes a plasma display panel 100, a controller 200, an address driver 300, a scan driver 400, a sustain driver 500 and a power supply 600.

The plasma display panel 100 includes a plurality of address electrodes (A1 to Am) arranged in a column direction, a plurality of sustain electrodes (X1 to Xn) arranged in a row direction so as to form pairs, and scan electrodes (Y1 to Yn). The sustain electrodes (X1 to Xn) are formed so as to correspond to the scan electrodes (Y1 to Yn). In addition, the plasma display panel 100 includes a substrate (not shown) on which the sustain electrodes (X1 to Xn) and the scan electrodes (Y1 to Yn) are arranged and a substrate (not shown) on which the address electrodes (A1 to Am) are arranged. The two substrates are arranged to face each other with a interposing discharge space therebetween, so as to enable the scan electrodes (Y1 to Yn) and the address electrodes (A1 to Am), and the sustain electrodes (X1 to Xn) and the address electrodes (A1 to Am) to be perpendicular to each other, respectively. The discharge spaces near the intersections of the address electrodes (A1 to Am), sustain electrodes (X1 to Xn) and scan electrodes (Y1 to Yn) forms discharge cells 110. The structure of the plasma display panel 100 is merely an example, and a plasma display panel with a different structure may be applied.

The controller 200 receives image signals and outputs an address drive control signal Sa, a sustain drive control signal Sx and a scan drive control signal Sy. In addition, the controller 200 divides one frame into a plurality of subfields and drives the signals accordingly. Each subfield includes a reset period, an address period and a sustain period. In addition, the controller 200 may include an image processor processing an image signal, and a logic operation unit for driving the plasma display panel 100 in cooperation with the image processor.

The address driver 300 receives the address drive control signal Sa from the controller 200 and applies a display data signal for selecting the discharge cells 110 to be displayed to each address electrode for the selected discharge cells 110.

The scan driver 400 receives the scan drive control signal Sy from the controller 200 and applies a drive voltage to the scan electrode (Y).

The sustain driver 500 receives the sustain drive control signal Sx from the controller 200 and applies a drive voltage to the sustain electrode (X).

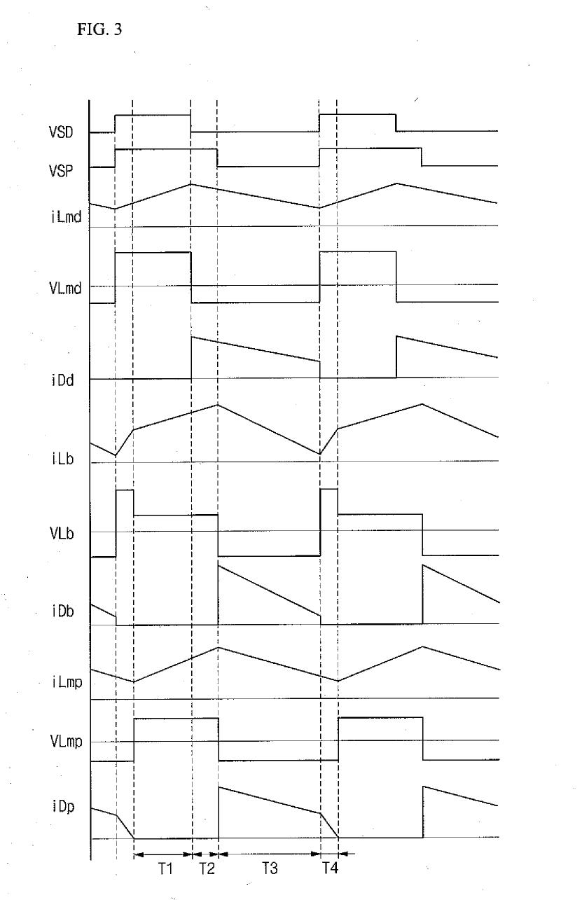

The power supply 600 supplies power to the controller 200 and each driver 300, 400 and 500 for driving the plasma display device. The power supply 600 is connected in parallel with a converter (DC converter and boost unit) for generating power of the DC converter and connected in serial with a capacitor used in each output terminal of the converter. Accordingly, the power supply 600 may have a rapid active response characteristic by reducing requirements for each converter and enabling the capacitor connected to output terminals of the converter to absorb a voltage change actively. The configuration of the power supply 600 will be explained in detail with reference to FIG. 2.

FIG. 2 is a circuit diagram illustrating a power supply according to one exemplary embodiment.

Referring to FIG. 2, the power supply 600 includes a boost unit 610, a power factor correction unit 620, a DC converter 630 and an output unit 640. The output unit 640 includes first and second capacitors Cp and Cd, which are connected to output terminals of the power factor correction unit 620 and the DC converter 630. Here, the first and second capacitors Cp and Cd are serially connected to each other.

The boost unit 610 is electrically coupled between an input power VIN, the power factor correction unit 620 and the DC converter 630. The boost unit 610 is not independently operated without a switching element but operates by sharing a correction switching element SP of the power factor correction unit 620. In other words, the boost unit 610 is dependent on the operation of the power factor correction unit 620.

The boost unit 610 includes a boost inductor Lb, a boost diode Db and a boost capacitor Cb. A first electrode of the boost inductor Lb is electrically coupled to a first electrode of the input power VIN and a second electrode thereof is electrically coupled to the anode of the boost diode Db and the power factor correction unit 620. The boost inductor Lb stores currents applied from the input power VIN during a period in which the correction switching element SP of the power factor correction unit 620 is turned on. The boost inductor Lb applies the currents, to the boost capacitor Cb during a period in which the correction switching element SP is turned off. Here, the boost capacitor Cb generates a DC voltage using the transmitted currents. The boost capacitor Cb supplies power when the input power VIN is not turned on.

An anode of the boost diode Db is electrically coupled to the second electrode of the boost inductor Lb and the power factor correction unit 620 and a cathode thereof is electrically coupled to the first electrode of the boost capacitor Cb and the DC converter 630. The boost diode Db transmits the currents stored in the boost inductor Lb to the boost capacitor Cb.

A first electrode of the boost capacitor Cb is electrically coupled to the cathode of the boost diode Db and the DC converter 630 and a second electrode thereof is electrically coupled to the second electrode of the input power VIN, the power factor correction unit 620 and the DC converter 630. The boost capacitor Cb generates a DC voltage through the currents transmitted from the boost inductor Lb and then stores the DC voltage. The boost capacitor Cb provides power to the DC converter 630. The minimum voltage charged in the boost capacitor Cb corresponds to the maximum voltage of the input power VIN according to a characteristic of the connection structure of the boost unit 610.

The power factor correction unit 620 is electrically coupled between the boost unit 610 and output unit 640 and is connected in parallel with the DC converter 630. The power factor correction unit 620 includes a correction switching element SP, a correction transformer TP and a correction diode Dp. The power factor correction unit 620 shares the correction switching element SP as an active switch with the boost unit 610. The boost unit 610 and the power factor correction unit 620 store power in the boost capacitor Cb and the first capacitor Cp and generate DC voltages, and preserve the phase of the AC voltages applied from the input power VIN.

A first electrode of the correction switching element SP is electrically coupled to the end P12 of the primary winding of the correction transformer TP. A second electrode thereof is electrically coupled to the second electrode of the boost capacitor Cb and the second electrode of the input power VIN, and a control electrode thereof is electrically coupled to a first control signal line VSP. The correction switching element SP is an N-type transistor and is turned on when a high-level control signal is applied to the control electrode through the first control signal line VSP. However, the correction switching element SP may be a P-type transistor or an element performing additional switching operations, but is not limited thereto. The correction switching element SP is turned on when a high-level control signal is applied through the first control signal line VSP so as to couple the first and second electrodes of the correction switching element SP. In other words, when the correction switching element SP is turned on, the correction switching element SP electrically couples the end NP12 of the primary winding of the correction transformer TP to the second electrode of the input power VIN.

The end NP11 of the primary winding of the correction transformer TP is electrically coupled to the second electrode of the boost inductor Lb and the anode of the boost diode Db, and the end NP12 of the primary winding is electrically coupled to the first electrode of the correction switching element SP. In addition, end NP21 of the secondary winding of the correction transformer TP is electrically coupled to the anode of the correction diode Dp, and the end NP22 of the secondary winding is electrically coupled to the output unit 640. In this embodiment, the inductance Lmp of the correction transformer TP is larger than the inductance of the boost inductor Lb so that an increase of the voltage stored in the boost capacitor Cb can be prevented.

An anode of the correction diode Dp is electrically coupled to one end NP21 of the secondary winding of the correction transformer TP, and a cathode thereof is electrically coupled to the output unit 640. The correction diode Dp is a rectifier diode. In addition, the correction diode Dp is reverse-biased and cut off when a current flowing into the boost inductor Lb is lower than a current flowing into the inductance Lmp of the correction transformer TP. Accordingly, the power factor correction unit 620 can reduce loss due to a reverse recovery current of the correction diode Dp.

The DC converter 630 is electrically coupled between the boost unit 610 and the output unit 640 and connected in parallel with the power factor correction unit 620. The DC converter 630 includes a DC switching element SD, a DC transformer TD and a DC diode Dd. The DC converter 630 generates a difference voltage between a final output voltage VOUT output through the output unit 640 and an output voltage Vp output through the first capacitor Cp. In other words, a voltage outputted through the second capacitor Cd electrically coupled to the output terminal of the DC converter 630 corresponds to a difference voltage between the final output voltage VOUT and the output voltage Vp of the power factor correction unit 620.

A first electrode of the DC switching element SD is electrically coupled to the end ND12 of the primary winding of the DC transformer TD, a second electrode thereof is electrically coupled to the second electrodes of the boost capacitor Cb and the input power VIN, and a control electrode thereof is electrically coupled to the second control signal line VSD. The DC switching element SD is an N-type transistor and is turned on when a high-level control signal is applied to the control electrode through the second control signal line VSD. However, the DC switching element SD may be a P-type transistor or an element for performing an additional switching operation, but is not limited thereto. The DC switching element SD is turned on when a high-level control signal is applied through the second control signal line VSD so as to couple the first and second electrodes of the DC switching element SD. In other words, the DC switching element SD is turned on so as to couple the end ND12 of the primary winding of the DC transformer TD to the second electrode of the input power VIN.

The end ND11 of the primary winding of the DC transformer TD is electrically coupled to the cathode of the boost diode Db and the first electrode of the boost capacitor Cb. The end ND12 of the primary winding is electrically coupled to the first electrode of the DC switching element SD and end ND21 of the secondary winding of the DC transformer TD is electrically coupled to the anode of the DC diode Dd. The end ND22 of the secondary winding is electrically coupled to the output unit 640. The DC transformer TD stores power in inductance Lmd. In addition, the DC transformer TD stores the power stored in the inductance Lmd in the second capacitor Cd through the secondary winding when the DC switching element SD is turned off.

An anode of the DC diode Dd is electrically coupled to end ND21 of the secondary winding of the DC transformer TD, and a cathode thereof is electrically coupled to the output unit 640. The DC diode Dd is a rectifier diode and power is stored in the inductance Lmd of the DC transformer TD when the DC diode Dd is reverse-biased and cut off. In addition, the DC diode Dd transmits power stored in the inductance Lmd to the second capacitor Cd of the output unit 640 when the DC diode Dd is biased and conducts.

The output unit 640 is electrically coupled to the power factor correction unit 620 and the DC converter 630. The output unit 640 includes a first capacitor Cp, a second capacitor Cd and an output capacitor Co.

A first electrode of the first capacitor Cp is electrically coupled to the cathode of the correction diode Dp and the second electrode of the second capacitor Cd, and a second electrode thereof is electrically coupled to the end NP22 of the secondary winding of the correction transformer TP. In other words, the first capacitor Cp is electrically coupled to output terminals of the power factor correction unit 620 and is connected in parallel with the second capacitor Cd. The first capacitor Cp outputs an output voltage Vp of the power factor correction unit 620.

A first electrode of the second capacitor Cd is electrically coupled to the cathode of the DC diode Dd, and a second electrode thereof is electrically coupled to the end ND22 of the secondary winding of the DC transformer TD and the first electrode of the first capacitor Cp. In other words, the second capacitor Cd is electrically coupled to an output terminal of the DC converter 630 and connected in serial with the first capacitor Cp. The second capacitor Cd outputs an output voltage Vd of the DC converter 630 corresponding to a difference voltage between a final output voltage VOUT output from the output capacitor Co and the output voltage Vp of the power factor correction unit 620. In other words, the output voltage Vd of the DC converter 630 outputs a voltage value so as to maintain the final output voltage VOUT substantially constant.

A first electrode of the output capacitor Co is electrically coupled to the first electrode of the second capacitor Cd and the cathode of the DC diode Dd, and a second electrode thereof is electrically coupled to the second electrode of the first capacitor Cp and the end NP22 of the secondary winding of the correction transformer TP. In other words, the output capacitor Co is additionally connected in parallel with the first and second capacitors Cp and Cd which are serially connected to each other. The second capacitor Cd reduces noise components of the final output voltage VOUT by shunting high-frequency components and the output capacitor Co outputs the final output voltage. Here, the value of the second capacitor Cd is desirably set to below about 1/10 of the output capacitor Co and thus mutual interference of each capacitor can be prevented, but the value of the capacitors Cd and Co are not limited thereto.

In the power supply 600, the first capacitor Cp is connected to the second capacitor Cd serially and power processed in the power factor correction unit 620 and the DC converter 630 is combined. Accordingly, the power supply 600 can reduce the output voltage Vp of the power factor correction unit 620 and the output voltage Vd of the DC converter 630 into about half of the final output voltage VOUT. In addition, the power supply 600 is serially connected to the first and second capacitors Cp and Cd, and the second capacitor Cd absorbs a change of the output voltage Vp of the power factor correction unit 620 and outputs an output voltage Vd of the DC converter 630. Accordingly, the final output voltage VOUT can be stably output. In other words, the power supply 600 can output the final output voltage VOUT stably.

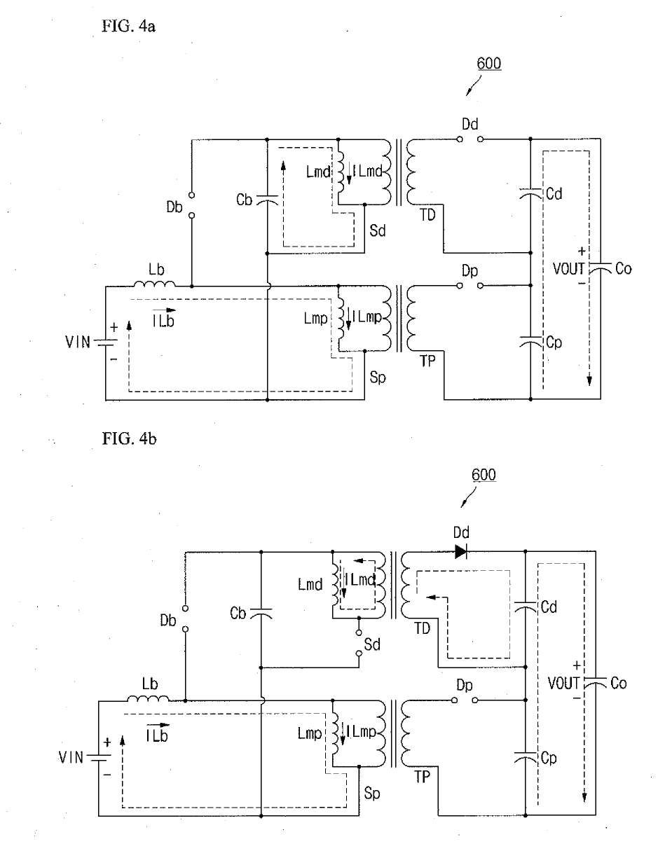

FIG. 3 illustrates a timing diagram of one exemplary embodiment of the power supply of FIG. 2.

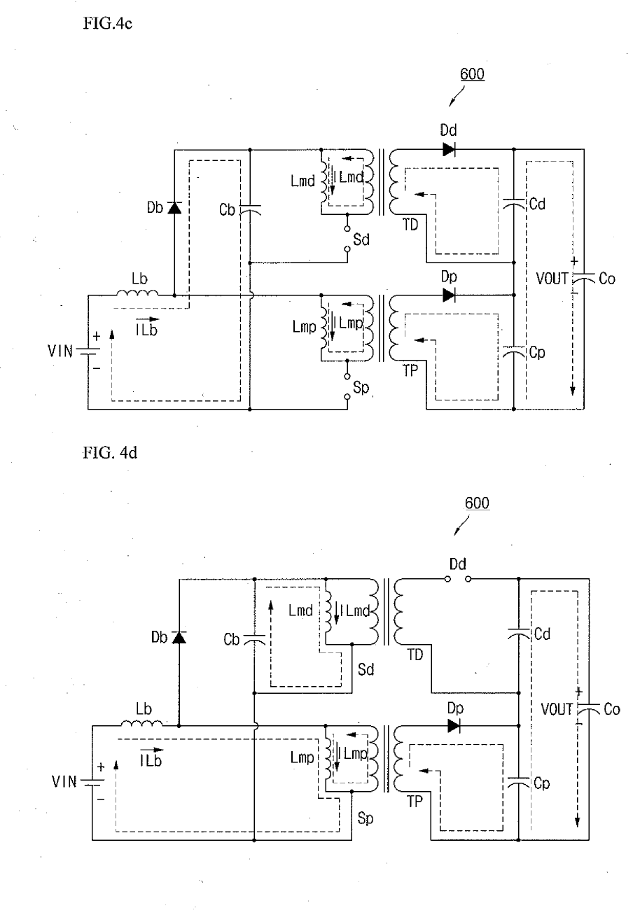

Referring to FIG. 3, the power supply 600 includes first, second and third driving periods T1, T2 and T3. The timing diagram of the power supply 600 illustrates a main voltage and a current waveform. In addition, the operation of the power supply 600 during each period will be explained in detail with reference to FIGS. 4a to 4d.

A signal that is different from a signal shown in FIG. 3 can be input to or output from the power supply 600 of FIG. 2 and the timing diagram of the power supply 600 is not limited to FIG. 3.

FIGS. 4a and 4d illustrate circuit diagrams of current flow during each period of the timing diagram of the power supply of FIG. 3.

Referring to FIG. 4a, during a first driving period T1, when a high-level control signal is applied to a control electrode of the correction switching element SP from the first control signal line VSP, the correction switching element SP is turned on. The correction switching element SP is turned on and a current flows through the boost inductor Lb, the correction transformer TP and the input power VIN. Therefore, energy is charged in the boost inductor Lb and the inductance Lmp of the correction transformer TP and a current iLb flowing into the boost inductor Lb and a current iLmp flowing into the magnetizing inductance Lmp of the correction transformer TP are increased. In addition, the voltage from the input power VIN reverse-biases the correction diode Dp through the secondary winding of the correction transformer TP and thus the correction diode Dp is off.

In addition, a high-level control signal is applied to the control electrode of the DC switching element SD from the second control signal line VSD and, accordingly, the DC switching element SD is turned on. In response, a current flows between the DC transformer TD and the boost capacitor Cb. The boost capacitor Cb transmits stored energy to the inductance Lmd of the DC transformer TD. Accordingly, current flowing into the inductance Lmd of the DC transformer TD is increased. In addition, the voltage across the boost capacitor Cb reverse-biases the DC diode Dd through the secondary winding of the DC transformer TD.

Referring to FIG. 4b, during the second driving period T2, a high-level control signal is applied to a control electrode of the correction switching element SP from the first control signal line VSP and the correction switching element SP is turned on. The correction switching element SP is turned on and current flows between the boost inductor Lb, the correction transformer TP and the input power VIN. Accordingly, energy is charged in the boost inductor Lb and the inductance Lmp of the correction transformer TP and current iLb flowing into the boost inductor Lb and current iLmp flowing into the inductance Lmp of the correction transformer TP are increased. In addition, the voltage applied from the input power VIN reverse-biases the correction diode Dp through the secondary winding of the correction transformer TP and thus the correction diode Dp is off.

In addition, a control signal in a low level is applied to the control electrode of the DC switching element SD from the second control signal line VSD, and the DC switching element SD is turned off. Accordingly the boost capacitor Cb transmits stored energy to the inductance Lmd of the DC transformer TD. And current iLmd flowing into the inductance Lmd of the DC transformer TD is increased. In addition, the voltage across the boost capacitor Cb is reverse-biases the DC diode Dd through the secondary winding of the DC transformer TD and thus the DC diode Dd is off.

Referring to FIG. 4c, during the third driving period T3, the correction switching element SP is turned off when a low-level control signal is applied to the control electrode of the correction switching element SP through the first control signal line VSP. As a result, the correction transformer TP conducts current to the correction diode Dp according to the current stored in the inductance Lmp during the first and second driving periods T1 and T2. In addition, the correction diode Dp is on and applies the conducted current to the first capacitor Cp.

In addition, the DC switching element SD is turned off when a low-level control signal is applied to a control electrode from the second control signal line VSD. As a result, the DC transformer TD conducts current to the DC diode Dd according to the current stored in the inductance Lmd during the first driving period T1. In addition, the DC diode Dd is on and applies the conducted current to the second capacitor Cd.

In addition, the correction switching element SP and the DC switching element SD are turned off, and a bias voltage is applied through the input power VIN, thus the boost diode Db is on. The boost diode Db is on, and thus a current flows through the input power VIN, the boost inductor Lb and the boost capacitor Cb. As a result, the boost capacitor Cb is charged when the current stored in the boost inductor Lb is applied to the boost capacitor Cb.

Referring to FIG. 4d, during the fourth driving period T4, the correction switching element SP is turned on when a high-level control signal is applied to the control electrode of the correction switching element SP from the first control signal line VSP. The correction switching element SP is on, and current flows through the boost inductor Lb, the correction transformer TP and the input power VIN. However, during the third driving period T3, current for charging the boost inductor Lb and the inductance Lmp of the correction transformer TP are different from each other and thus initial values of the currents are different from each other. Therefore, the correction transformer TP doesn't use the input power VIN as a power source any more, and thus the correction diode Dp electrically coupled to the secondary winding is on. In addition, the first capacitor Cp applies current to the boost inductor Lb electrically coupled to the primary winding of the correction transformer TP through the correction diode Dp with the voltage stored during the third driving period T3. Therefore, the voltage applied to the boost inductor Lb is increased and thus the current thereof is increased. When the current of the boost inductor Lb is the same as the current of the magnetizing inductance Lmp of the correction transformer TP, the correction diode Dp electrically coupled to the secondary winding of the correction transformer TP is reverse-biased and is thus turned off. In other words, when current of the boost inductor Lb is larger than the current of the inductance Lmp of the correction transformer TP, the correction diode Dp is off. Accordingly, loss due to a reverse-recovery current of the diode and switching noise can be reduced.

Accordingly, energy is charged in the boost inductor Lb and the inductance Lmp of the correction transformer TP and thus current iLb flowing into the boost inductor Lb and current iLmp flowing into inductance Lmp of the correction transformer TP are increased. In addition, the voltage applied from the input power VIN is reverse-biases the correction diode Dp through the secondary winding of the correction transformer TP, and thus the correction diode Dp is off.

In addition, the DC switching element SD is turned on when a high-level control signal is applied to the control electrode from the second control signal line VSD. The DC switching element SD is turned on and current flows between the DC transformer TD and the boost capacitor Cb. The boost capacitor Cb transmits stored energy to the inductance Lmd of the DC transformer TD. Accordingly, current iLmd flowing into the inductance Lmd of the DC transformer TD is increased. In addition, a voltage across the boost capacitor Cb reverse-biases the DC diode Dd through the secondary winding of the DC transformer TD, and thus the DC diode Dd is off.

As described above, the power supply and the plasma display device having the same produce at least the following effects.

First, the power can be distributed and reduced by serially connecting the capacitor to the output terminals of the power factor correction unit and DC converter.

Second, the final output voltage can be stably output by supplementing the change of the output voltage change of the power factor correction unit with the output voltage of the DC converter.

It should be understood by those of ordinary skill in the art that various replacements, modifications and changes in the form and details may be made without departing from the spirit and scope of the present invention. Therefore, it is to be appreciated that the above described embodiments are for purposes of illustration only.

What is claimed is:

1. A power supply, comprising:
a boost unit electrically coupled to an input power;
a DC converter electrically coupled to the boost unit;
a power factor correction unit, electrically coupled to the boost unit, being connected in parallel to the DC converter; and
an output unit electrically coupled to the power factor correction unit and to the DC converter, the output unit configured to output power,
wherein the output unit comprises:
a first capacitor electrically coupled between output terminals of the power factor correction unit; and
a second capacitor that is electrically coupled between output terminals of the DC converter and connected in serial with the first capacitor.

2. The power supply of claim 1, wherein the boost unit comprises:
a boost inductor electrically coupled between a first electrode of the input power and the power factor correction unit;
a boost diode electrically coupled to the boost inductor; and
a boost capacitor connected across input terminals of the DC converter

3. The power supply of claim 2, wherein a first electrode of the boost inductor is electrically coupled to the first electrode of the input power and a second electrode of the boost inductor is electrically coupled to an anode of the boost diode.

4. The power supply of claim 2, wherein an anode of the boost diode is electrically coupled to the second electrode of the boost inductor and the power factor correction unit and a cathode of the boost diode is electrically coupled to a first electrode of the boost capacitor and to the DC converter.

5. The power supply of claim 2, wherein a first electrode of the boost capacitor is electrically coupled to the cathode of the boost diode and to the DC converter and a second electrode of the boost capacitor is electrically coupled to the DC converter and to the power factor correction unit.

6. The power supply of claim 2, wherein the power factor correction unit comprises:
a correction switching element electrically coupled to the input power and to the boost capacitor;
a correction transformer, comprising:
a primary winding, electrically coupled between the correction switching element and the boost inductor; and
a secondary winding, electrically coupled to the first capacitor of the output unit; and
a correction diode electrically coupled to the secondary winding of the correction transformer.

7. The power supply of claim 6, wherein one end of the primary winding of the correction transformer is electrically coupled to the boost inductor and to the boost diode, and the other end of the primary winding is electrically coupled to the first electrode of the correction switching element, and wherein one end of the secondary winding is electrically coupled to the anode of the correction diode, and the other end of the secondary winding is electrically coupled to a second electrode of the first capacitor.

8. The power supply of claim 6, wherein a first electrode of the correction switching element is electrically coupled to the primary winding of the correction transformer, a second electrode of the correction switching element is electrically coupled to the second electrode of the input power and the second electrode of the boost capacitor, and a control electrode of the correction switching element is electrically coupled to a first control signal line.

9. The power supply of claim 6, wherein an anode of the correction diode is electrically coupled to one end of the secondary winding of the correction transformer, and a cathode of the correction diode is electrically coupled to the first electrode of the first capacitor and to the second electrode of the second capacitor.

10. The power supply of claim 6, wherein an inductance of the boost inductor is less than an inductance of the correction transformer.

11. The power supply of claim 2, wherein the DC converter comprises:
a DC switching element electrically coupled to the input power and to the second electrode of the boost capacitor;
a DC transformer, comprising:
a primary winding electrically coupled between the DC switching element and the boost capacitor; and
a secondary winding electrically coupled to the second capacitor of the output unit; and
a DC diode electrically coupled to the secondary winding of the DC transformer.

12. The power supply of claim 11, wherein one end of the primary winding of the DC transformer is electrically coupled to the first electrode of the boost capacitor and to the cathode of the boost diode, and the other end of the primary winding is electrically coupled to the first electrode of the DC switching element, and wherein one end of the secondary winding is electrically coupled to the anode of the DC diode and the other end of the secondary winding is electrically coupled to the second electrode of the second capacitor and to the first electrode of the first capacitor.

13. The power supply of claim 11, wherein a first electrode of the DC switching element is electrically coupled to the primary winding of the DC transformer, and a second electrode of the DC switching element is electrically coupled to the second electrode of the boost capacitor and to the input power, and a control electrode of the DC switching element is electrically coupled to the second control signal line.

14. The power supply of claim 11, wherein an anode of the DC diode is electrically coupled to one end of the secondary winding of the DC transformer and a cathode of the DC diode is electrically coupled to the first electrode of the second capacitor.

15. The power supply of claim 1, wherein the output unit further comprises an output capacitor connected in parallel with the first and second capacitors, wherein the first and second capacitors are serially connected to each other.
